(19) United States
(12) Patent Application Publication
(10) Pub. No.: US 2010/0040046 A1
(43) Pub. Date: Feb. 18, 2010

(54) VOIP DATA PROCESSING METHOD

(75) Inventor: Cheng-Hung KO, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/191,730

(22) Filed: Aug. 14, 2008

(51) Int. Cl. H04L 12/56

(52) U.S. Cl. 370/352

(57) ABSTRACT

A method of processing data in a communication apparatus in a local network is provided. The method comprises receiving, at the communication apparatus, a first Internet Protocol (IP) data packet, comparing at least one bit of leading bytes with a predetermined value, determining the first IP data packet belongs to a control signal data packet and processing the first IP data packet according to the control signal data packet when the bit of leading bytes is less than or equal to the predetermined value, and determining the first IP data packet belongs to a multimedia data packet and processing the first IP data packet according to the multimedia data packet when the bit of leading bytes exceeds the predetermined value.

### BACKGROUND OF THE INVENTION

1. Field of the Invention

The invention relates in general to voice over IP (VoIP), and in particular, to a data processing method for VoIP.

2. Description of the Related Art

Data packets are transmitted over the Internet to arrive at a desired destination according to Internet Protocols. Often, data streams must be delivered from a public network to a local node in a private network and vice versa. In these situations, data are delivered to or from a local node through an entry or exit point of the private network. Typically, a Network Address Translation (NAT) server is employed to serve as the entry and exit point to deal with the problem of an IP address shortage and to increase efficiency of the network interfaces. The NAT server translates private IP addresses of network devices in the private network for the public network such that the private individual IP addresses are concealed from the public network.

Voice over Internet Protocol (VoIP) comprises a set of internet protocols optimized for the transmission of voice through the Internet or other packet switched networks. Voice over IP can be implemented by SIP (Session Initiation Protocol) developed by the IETF (Internet Engineering Task Force), an application-level control protocol which allows the establishment, alteration and interruption of media connections and voice over IP connections. The Session Initiation Protocol (SIP) is an application-layer control (signaling) protocol for creating, modifying, and terminating sessions with one or more participants, creating multiparty or multicast sessions that include voice over IP, multimedia distribution, and multimedia conferences. Further, the voice and video data stream transmission is carried by the Real-Time Transport Protocol (RTP), which defines a standardized packet format for delivering audio and video over the Internet. The RTP packets are properly routed to the intended destination along a multimedia data path, typically at a public exposed IP address and port number different from the control signal path implemented by the SIP. The RTP data packet delivered to the NAT of the private network must then route the data to the intended destination within the private network.

NATs can cause problems in cases where network devices such as SIP phones are located behind a NAT. Both the SIP and RTP data packets comprise header and payload portions. When address information to be delivered over the NAT is carried in the payload portion, the public network cannot locate the destination address of the returned SIP or RTP messages according to the address information in the payload. This means that all traffic returning to the NAT will be mapped onto one client causing the service to fail.

Therefore, there exists a need to provide a method to route SIP or RTP data to proper public IP addresses and port numbers to establish a control signal or a multimedia data path between a destinations node within a private network and a public network.

### BRIEF SUMMARY OF THE INVENTION

A detailed description is given in the following embodiments with reference to the accompanying drawings.

A method of processing data in a communication apparatus in a local network is disclosed, comprising receiving, at the communication apparatus, a first Internet Protocol (IP) data packet, comparing at least one bit of leading bytes of the first IP data packet with a predetermined value, determining whether the first IP data packet belongs to a control signal data packet and processing the first IP data packet as processing a control signal data packet when the bits of the leading bytes is less than or equal to the predetermined value, and determining whether the first IP data packet belongs to a multimedia data packet and processing the first IP data packet as processing a multimedia data packet when the bits of the leading bytes exceeds the predetermined value.

### BRIEF DESCRIPTION OF THE DRAWINGS

The invention can be more fully understood by reading the subsequent detailed description and examples with references made to the accompanying drawings, wherein:

FIG. 1 is a block diagram of an exemplary voice over IP (VoIP) communication system according to an embodiment the invention.

FIG. 2 is a timing chart illustrating a conventional RTP session establishment for transmitting RTP data.

FIG. 3 is a timing chart illustrating a conventional SIP registration procedure.

FIG. 4 is a timing chart showing an exemplary SIP registration procedure according to the invention.

FIG. 5 is a flowchart of an exemplary method for processing data packets in the communication apparatus in a local network according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Messages or data packets being transmitted in networks typically contain a header and payload. The address information may be included in the payload portion of the data packet in some applications, such as registration information. When data packets are transmitted through a network, specific source IP address and/or port number information are changed in the header. Since NAT translates the source IP addresses as data packets that passes therethrough, applications that use IP addresses carried in the payload portion would fail in the presence of the NAT. Thus, conventional VoIP services cannot be provided to a NAT-based private network, without additional costly solutions. The present invention provides a solution to support VoIP services compatible with the NAT without the requirement of an external STUN server, such that the data packet may be routed properly to the desired destination from a public network source to a local destination node in a private network and vice versa.

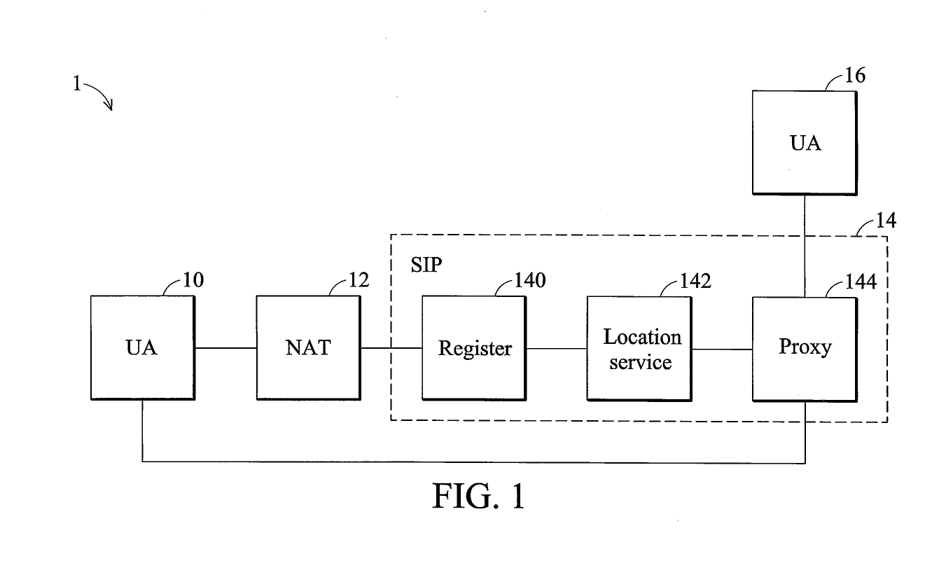

In an exemplary embodiment of the present invention, the Session Initiation Protocol (SIP) is used for signaling control and Real-Time Transport Protocol (RTP) is used for media data transmission to provide VoIP services. FIG. 1 is a block diagram of an exemplary voice over IP (VoIP) communication system using SIP and RTP protocols according to the invention, comprising a communication apparatus 10, an NAT server 12, a SIP server 14, and a remote communication apparatus 16. The communication apparatus 10 is coupled to the NAT server 12, the SIP server 14, and then to the remote communication apparatus 16. For illustration purposes, FIG. 1 shows user agents (UA) 10 and 16, wherein UA 10 has a private IP address and UA 16 has a public address. UA 10 has a globally unique registered IP address provided by the NAT that is recognized by the public network including the remote communication apparatus 16.

The VoIP system 1 employs the SIP protocol to transmit a request, a response, or a message in which activities of a session established between a local communication apparatus and a remote apparatus are described as follows. Prior to establishing the session, the communication apparatus in the private network needs to register an address in a SIP server so that the remote apparatus can locate and exchange multimedia data with the communication apparatus. SIP messages are carried in the payload of the UDP/IP packets with the header containing the source and destination addresses and port numbers.

The SIP server 14 comprises a register unit 140, a location service unit 142, and a proxy server 144 coupled in series. The communication apparatus sends REGISTER request including its public address to the register unit 140 for registration, whereafter the register unit 140 then stores the public address in a location service unit 142. When a call is placed from a remote communication apparatus 16 to a communication apparatus 10, for example, a call signaling path is set up by the remote communication apparatus 16 by delivering an INVITE request to a proxy server 144, whereafter the proxy server 144 firstly queries the location of the communication apparatus 10 by sending a query request to the location service unit 142, and subsequently receives the public address of the communication apparatus 10 so that the proxy server 144 can further accordingly forward the INVITE request for media session establishment. If the public address is correct, communication apparatus 10 would receive the INVITE request and respond by a SIP 180 Ringing response while waiting for acceptance of the INVITE request. Upon acceptance the INVITE request, the communication apparatus 10 would transmit a SIP 200OK response to the remote communication apparatus 16, and in response to the SIP 200 OK response, the remote communication apparatus 16 would send an ACK response to the communication apparatus 10 and start exchanging data packets.

The communication apparatus 10 comprises a user agent performing registration in a SIP server 14 and establishing the media session with the remote communication apparatus 16 according to a session initiation protocol. The communication apparatus 10 exchanges signals with the SIP server 14 through the NAT server 12, i.e., the source address of the outgoing packets is converted to the public address and the destination address of the incoming packets is converted back to the private address when data packets are passed through the NAT server 12. The NAT server 12 translates the private to public IP addresses, converts the TCP/UDP port numbers of IP packets as they pass therethrough, and retains an NAT table recording the mapped private and public IP addresses and mapped port numbers. There is a 1:1 correspondence between publicly exposed IP addresses and privately held IP addresses, and the external and internal port numbers in the NAT table. Upon receipt of the incoming packets, the NAT device 12 redirects the incoming packets from a specific external IP address and external port number to an internal IP address and internal port number according to the NAT table.

Register unit 140 receives a REGISTER request from the communication apparatus 10, extracts the public address information in the REGISTER request for storage in a location service unit 142, and sends a success response (SIP 200 OK) to the communication apparatus 10. During the media session, in addition to the signal path being regulated by the SIP, multimedia data are exchanged between the communication apparatus 10 and the remote communication apparatus 16.

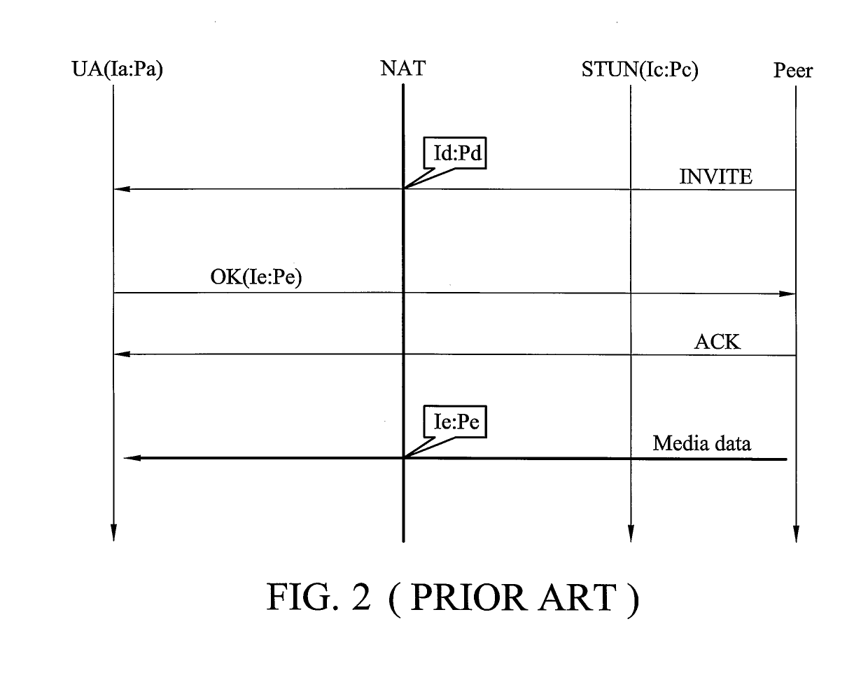

FIG. 2 is a timing chart illustrating a conventional RTP session establishment for transmitting RTP data. In the embodiment, a control signal path has been established prior to a media data path. The remote communication apparatus 16 places a VoIP call request by sending an INVITE request to the control signal path at the public IP address Id and the external port number Pd on the NAT, which redirects the INVITE request to the communication apparatus 10. In response to the INVITE request, the communication apparatus 10 sends the SIP 200 OK response containing the RTP public address information (Ie: Pe), which is different from the control signal path (Id: Pd), to the remote communication apparatus 16. The RTP public address information comprises the public IP address Ie and the external port number Pe for the media data path. In return, the remote communication apparatus 16 replies to the SIP ACK response along the control signal path (Id: Pd) to acknowledge receipt of the SIP 200 OK response, and transmits media data packets according to the new address information (Ie: Pe).

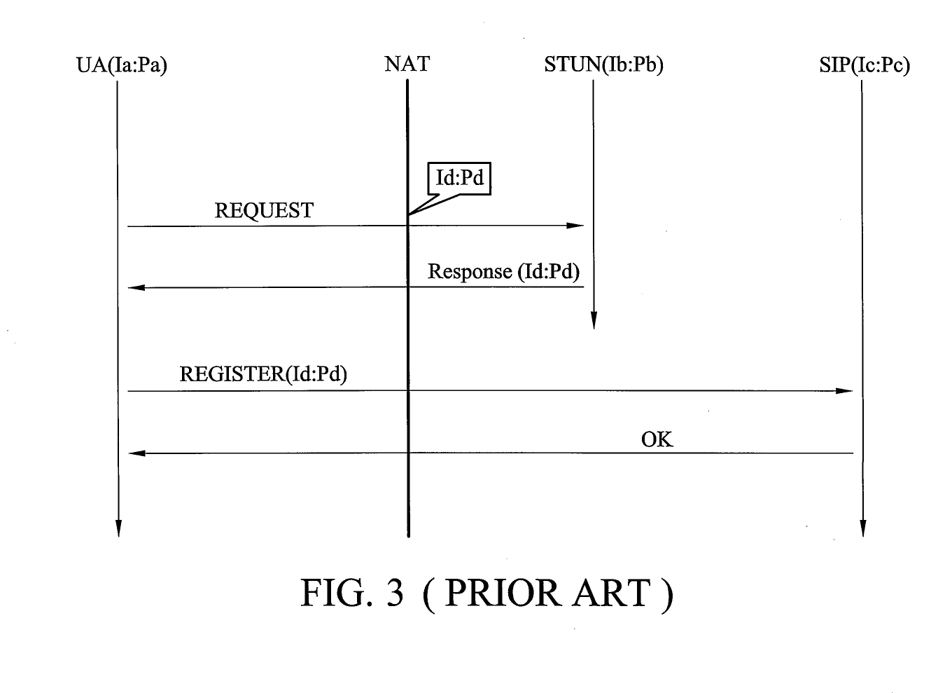

FIG. 3 is a timing chart illustrating a conventional SIP registration procedure, incorporated in the RTP session establishment in FIG. 2.

In the exemplary embodiment in FIG. 3, a user agent sends a request to a STUN server to query for the address information for the RTP path, and receives a response with the global IP address Id and the port number Pd from the STUN server. The user agent then sends a REGISTER request containing the public address Id and port number Pd to the SIP server, and receives an SIP 200 OK response upon successful registration for the public address Id and the port number Pd. Thus, when the remote communication apparatus 16 desires to make a VoIP call by issuing an INVITE request to a proxy server 144, the proxy server 144 can direct the INVITE request to the communication apparatus 10 along the control signal path (Id: Pd). In the same way, the public address Ie and the port number Pe used in the RTP session establishment can be obtained through the interaction with the STUN server. Note that the RTP data packets along the RTP media data path (Ie: Pe), or the SIP data packets along the control signal path (Id: Pd), can only passed through a non-symmetric NAT server 12. When the NAT server 12 is a symmetric NAT, the data packets cannot pass through the NAT server 12 since the destination address Ie and the port number Pe, or the destination address Id and the port number Pd, can only be transferred to the private address and port number if the source address and port number are the address and port number of the STUN.

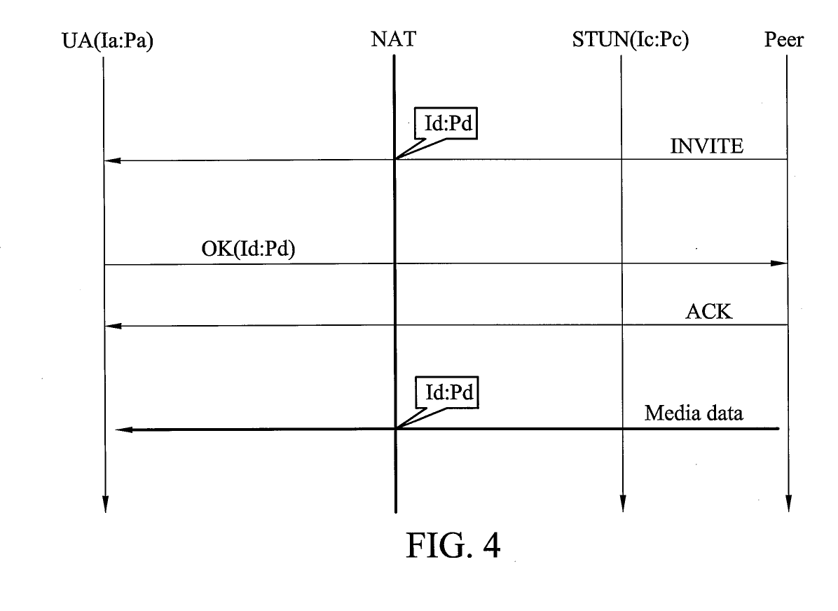

FIG. 4 is a timing chart showing an exemplary RTP registration procedure according to the invention, incorporating the communication system in FIG. 1. In the illustrated embodiment, the communication apparatus 10 receives an INVITE request along the control signal path (Id: Pd) upon an VoIP call, responds to an SIP 200 OK message containing the address information that is identical to the control signal path (Id: Pd), receives an ACK message from the remote communication apparatus 16, and receives both the SIP signal and the RTP media data packets along the same path, i.e., both the control signal path and media data path are sent to the public IP address Id and the external port number Pd on the NAT 12.

The embodiment in FIG. 4 responds the INVITE request with the address identical to the control signal path address (Id: Pd), instead of the conventional separate address for the multimedia data path (Ie: Pe), establishing the control signal and the multimedia data paths through the common public IP address Id and the external port number Pd, and demultiplexing the control signal and the multimedia data using the data size information in the received data.

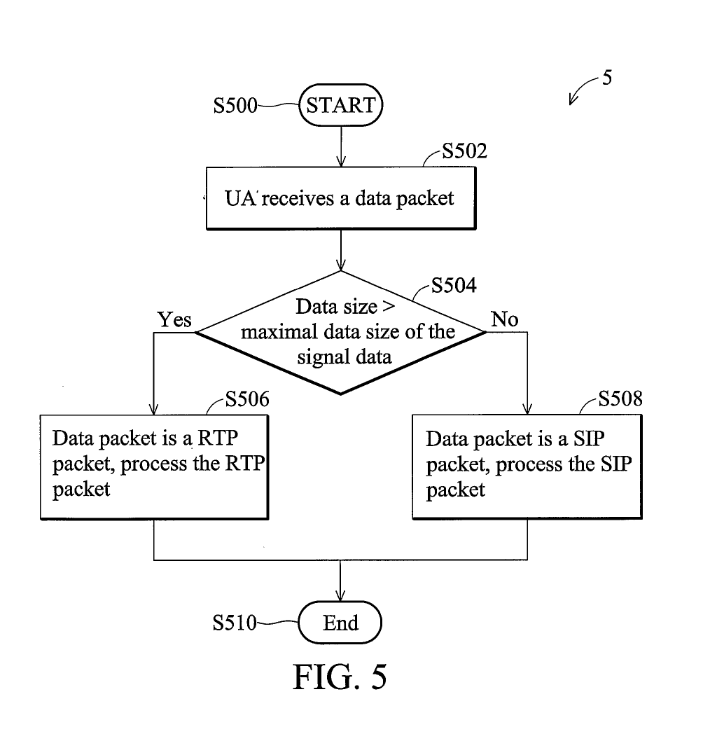

FIG. 5 is a flowchart of an exemplary method for processing data packets in the communication apparatus in a local network according to the invention, incorporating the communication system in FIG. 1.

Upon the start of data processing procedure in S500, the communication apparatus 10 receives a first Internet Protocol (IP) data packet (S502). The first IP data packet may carry Voice over Internet Protocol (VoIP) messages, and the Voice over Internet Protocol may be a Session Initiation Protocol or a Real-time Transfer Protocol. In the embodiment, the communication apparatus 10 retrieves SIP and RTP data packets through one single set of public IP address Id and the external port number Pd, thus making it necessary to identify the data packet type prior to data processing. Let data size be the value of the leading bits or bytes in a data packet. One way to distinguish the data packet type would be the use of the data size information in the data packet. In cases of SIP and RTP data packets, the data size, using the leading 8 bits, for an SIP message is less than 127 (0−127), and for an RTP message, the data size, using the leading 8 bits, exceeds 127 (128−255). Since the communication apparatus 10 is located within a private network, the first IP data packet is received through a NAT server, and in particular, a non-symmetric NAT server.

Next in step S504, the communication apparatus 10 compares the leading bytes of the first IP data packet with a predetermined value, for example, compares the data size with a predetermined data size limit, carries on step S506 if the leading bytes exceeds the predetermined value (e.g. data size exceeds the predetermined data size limit), and goes to step S508 if the leading bytes is less than or equal to the predetermined value (e.g. data size is less than or equal to the predetermined data size limit). In one embodiment the predetermined data size limit is 127, and the comparison may be conducted by determining the first bit of the leading byte of the first IP data packet, such as determining whether the data size is less than or equal to the predetermined data size limit when the leading bit is 0, and determining whether the data size exceeds the predetermined data size limit when the leading bit is 1.

In step S506, the communication apparatus 10 determines the first IP data packet belongs to a multimedia data packet and processes the first IP data packet as processing a multimedia data packet. The multimedia data packet may be the RTP data packet.

In step S508, the communication apparatus 10 determines the first IP data packet belongs to the control signal data packet and processes the first IP data packet as processing a control signal data packet. The multimedia data packet may be the SIP data packet.

Upon the completion of data processing for either the multimedia data packet or the control signal data packet, the data process method 5 exits at step S510.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of processing data in a communication apparatus in a local network, comprising:
receiving, at the communication apparatus, a first Internet Protocol (IP) data packet;
comparing at least one bit of leading bytes of the first IP data packet with a predetermined value;
determining the first IP data packet belongs to a control signal data packet and processing the first IP data packet as processing a control signal data packet when the bit of leading bytes is less than or equal to the predetermined value; and
determining the first IP data packet belongs to a multimedia data packet and processing the first IP data packet as processing a multimedia data packet when the bit of leading bytes exceeds the predetermined value.

2. The method of claim 1, wherein the First IP data packet comprises header and payload portions, and the comparing step comprises comparing at least one bit of a data size from the header.

3. The method of claim 1, wherein the control signal data packet carries Session Initiation Protocol (SIP) messages and the multimedia data packet carries Real-time Transfer Protocol (RTP) data.

4. The method of claim 1, wherein the predetermined value is 0.

5. The method of claim 1, wherein the first IP data packets carries Voice over Internet Protocol (VoIP) messages.

6. The method of claim 1, wherein the receiving step comprises receiving the first IP data packet through a non-symmetric Network Address Translation (NAT) server.

7. The communication method of claim 1, wherein the comparing step comprises comparing a data size indicated by the leading bytes of the first IP data packet.
